(19) United States
(12) Patent Application Publication
(10) Pub. No.: US 2006/0119533 A1
(43) Pub. Date: Jun. 8, 2006

(54) [DUAL-BAND ANTENNA]

(75) Inventor: CHURNG-JOU TSAI, TAIPEI (TW)

Correspondence Address: ANTENNIQUES CORP. LTD., P. O. BOX 108-00403, TAIPEI, TW

(73) Assignee: ANTENNIQUES CORP.LTD., SHULIN CITY, TAIPEI HSIEN, (TW)

(21) Appl. No.: 10/904,927

(22) Filed: Dec. 6, 2004

(51) Int. Cl. H01Q 9/30

(52) U.S. Cl. 343/900; 343/702

(57) ABSTRACT

A dual-band antenna includes a resonator holder holding a resonator, which is formed of a first metal barrel and a second metal barrel axially spaced from the first metal barrel at a gap about 1/10λ˜ 1/25λ of the high band's center carrier for enabling the bandwidth of the high band and the low band to be broadenable and the impedance matching to be adjustable by means of changing the gap between the first metal barrel and the second metal barrel, a shell capped on the resonator holder to protect the resonator, and a signal line inserted through the resonator holder with the tubular braided conducting layer connected to the first metal barrel and the center conductor soldered to second the metal barrel.

### BACKGROUND OF THE INVENTION

1. Field of the Invention

The present invention relates to an antenna and more particularly, to a dual-band antenna, which has the first metal barrel and second metal barrel of the resonator axially spaced at a gap about 1/10λ˜ 1/25λ of the high band's center carrier so that the bandwidth of the high band and the low band can be broadened and the impedance matching can be adjusted by means of changing the gap between the first metal barrel and the second metal barrel.

2. Description of the Related Art

In recent years, the development of wireless communication industry causes a great interference to the living of human beings. Following fast development of the Internet and communication technology, diversification of communication services and monolithic systems, communication industry integration and communication technology integration become inevitable, and a variety of high-tech products are developed. The development of these high-tech products, such as mobile telephone, PDA (Personal Data Assistant), GPS (Global Positioning System), and etc. are in a revolution toward light, thin, short and small. For high efficient working, high-tech products may be combined with communication technology. Same as other high-tech products, an antenna must have the product characteristics of light, thin, short and small physical features. Every antenna manufacturer has been trying hard to create mini-scaled antenna with improved function. An early design of antenna can only receive wireless signal from a particular bandwidth. In order to improve this problem, dual-band antennas are developed. A dual-band antenna provides two resonant paths in a single antenna structure, similar to dominant mode and high order mode in waveguide or the multi-mode transmission path produced in fiber-optic communication by means of the application of a laser beam at different incident angles. Therefore, a dual-band antenna creates two radiation passages. Except these two radiation passages, the magnetic energy cannot use the closed-loop structure of the antenna for signal transmission. When examined with an analyzer on antenna's return loss to find the position of resonance, the resistance value at the point of resonance is about 50Ω and the impedance is about zero to ensure impedance matching.

FIG. 7 shows a multi-band antenna according to the prior art. As illustrated, the antenna comprises a holder base A holding a coaxial cable A1, and a metal wire conductor B axially forwardly extended from the coaxial cable A1. The metal wire conductor B has two coiled portions B1 and B2 connected in series. The two coiled portions B1 and B2 have different pitches and diameters for receiving different signals of different bandwidths. This design of multi-band antenna is still not satisfactory in function. Because the metal wire conductor B has two coiled portions B1 and B2 connected in series, it requires much longitudinal installation space in an electronic product (for example, network exchanger, network card). Therefore, this design does not satisfy the market demand for physical measurements—light, thin, short, and small. Further, because the metal wire conductor B has a certain length and is suspended on the outside, it tends to be deformed by an external body during transportation. Further, because the two coiled portions B1 and B2 of the metal wire conductor B are formed by a mold, a new mold should be used when wishing to change the pitches and diameters of the coiled portions B1 and B2 in order to adjust the bandwidth and impedance matching. However, it takes much time and cost to prepare a new mold of a different specification.

Besides, another dual-band antenna, which uses two axially spaced hollow metal barrels to cause high band resonance during resonating of low band signal. This invention eliminates the drawbacks of big size and being easy to deform during transportation of the aforesaid prior art design.

### SUMMARY OF THE INVENTION

The present invention has been accomplished under the circumstances in view. It is therefore the main object of the present invention to provide a dual-band antenna, which enables the bandwidth of the high band and the low band to be broadenable and the impedance matching to be adjustable in an economic way without creasing a new mold or using a new fabrication implement. To achieve this and other objects of the present invention, the dual-band antenna comprises a resonator holder; and a metal resonator formed of a first metal barrel and a second metal barrel and connected to the resonator holder for receiving signals, a conductor shell capped on the resonator holder to protect the resonator, and a coaxial cable inserted through the resonator holder with the tubular braided conducting layer connected to the first metal barrel and the center conductor soldered to the second metal barrel, wherein the first metal barrel and the second metal barrel are axially spaced from each other by a gap at about 1/10λ˜ 1/25λ of the high band's center carrier so that the bandwidth of the high band and the low band can be broadened and the impedance matching can be adjusted by means of changing the gap between the first metal barrel and the second metal barrel.

### BRIEF DESCRIPTION OF THE DRAWINGS

FIG. 1 is an exploded view of dual-band antenna according to the present invention.

FIG. 2 is a sectional exploded view of the dual-band antenna according to the present invention.

FIG. 3 is an elevational view of the dual-band antenna according to the present invention.

FIG. 4 is standing wave ratio chart obtained from a use of the dual-band antenna according to the present invention.

FIG. 5 is a return loss chart obtained from a use of the dual-band antenna according to the present invention.

FIG. 6 is a sectional exploded view of an alternate form of the dual-band antenna according to the present invention.

FIG. 7 is a side view of a dual-band antenna according to the prior art.

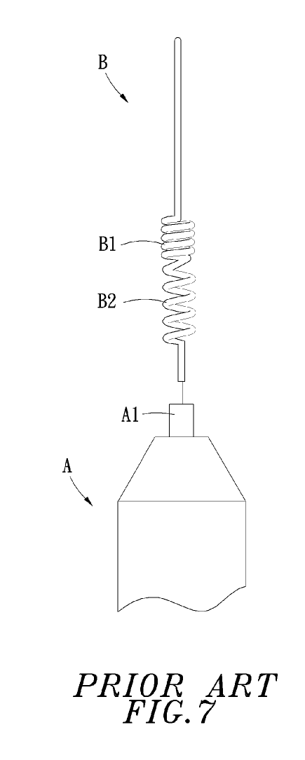

### DETAILED DESCRIPTION OF THE PREFERRED EMBODIMENT

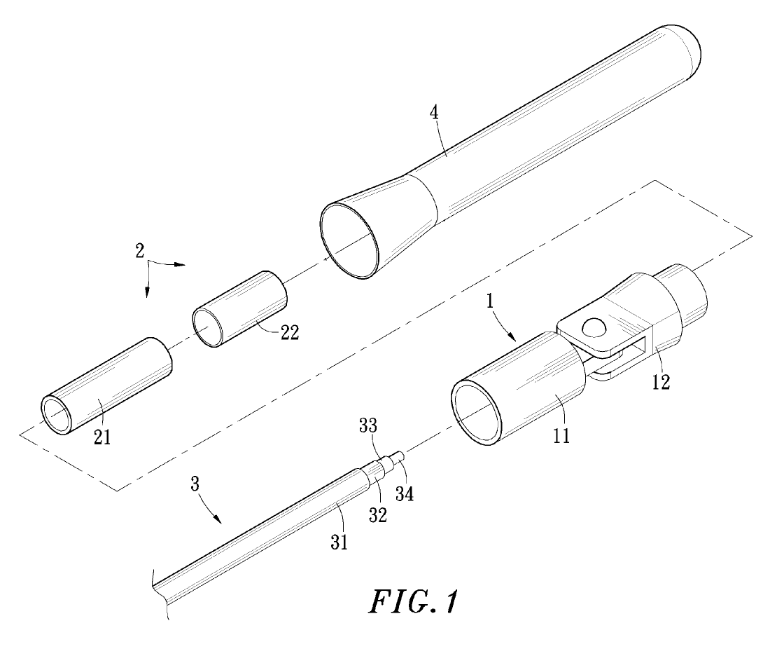

Referring to FIG. 1, a dual-band antenna in accordance with the present invention is shown comprised of a resonator holder 1, a resonator 2, a signal line 3, and an inductor shell 4.

The resonator holder 1 comprises a holder base 12 and a mounting base 11. The holder base 12 is coupled to the mounting base 11 and rotatable in axial direction relative to the mounting base 11.

The resonator 2 is comprised of a first metal barrel 21 and a second metal barrel 22. The first metal barrel 21 and the second metal barrel 22 are axially aligned in a line and spaced from each other by a gap.

The signal line 3 is a coaxial cable comprising an outer insulative layer 31, a tubular braided conducting layer 32, an inner insulative layer 33, and a center conductor 34. The center conductor 34 is covered within the inner insulative layer 33. The tubular braided conducting layer 32 is covered on the periphery of the inner insulative layer 33 within the outer insulative layer 31.

The inductor shell 4 is a hollow, cylindrical, electrically insulative cover member.

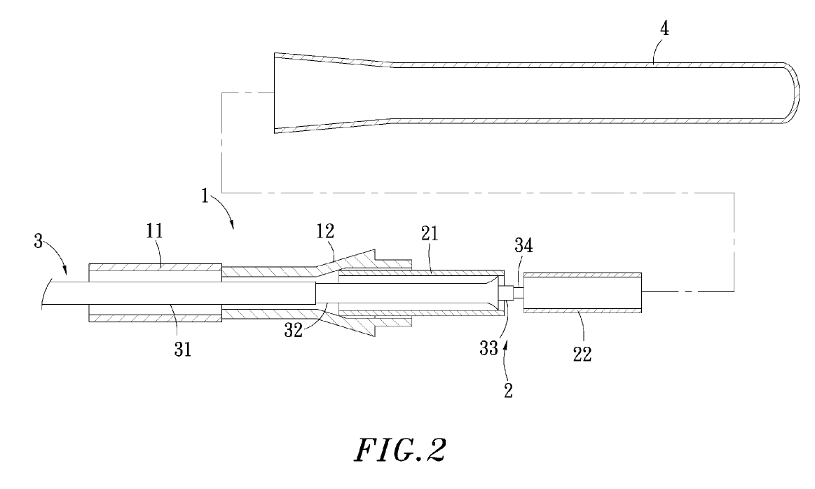

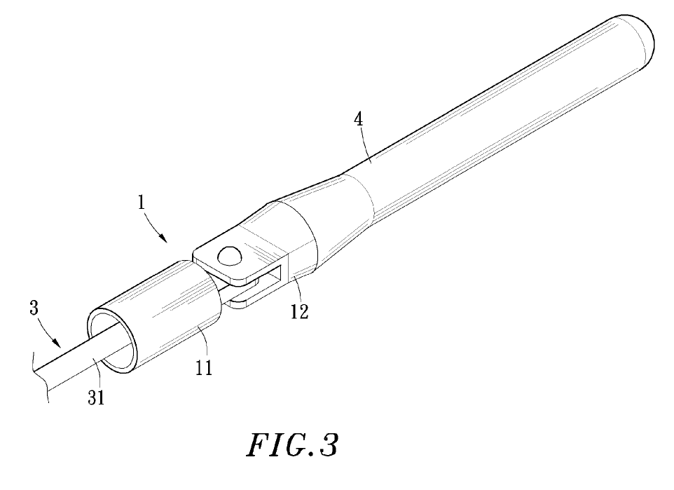

Referring to FIGS. 2 and 3 and FIG. 1 again, during assembly, the first metal barrel 21 of the resonator 2 is connected to the holder base 12 of the resonator holder 1, and then the signal line (coaxial cable) 3 is inserted in proper order through the mounting base 11, the holder base 12 and the first metal barrel 21, and then the center conductor 34 and the tubular braided conducting layer 32 of the signal line (coaxial cable) 3 are respectively soldered to the second metal barrel 22 and the first metal barrel 21, and then the inductor shell 4 is capped on the holder base 12 of the resonator holder 1 to protect the resonator 2 on the inside.

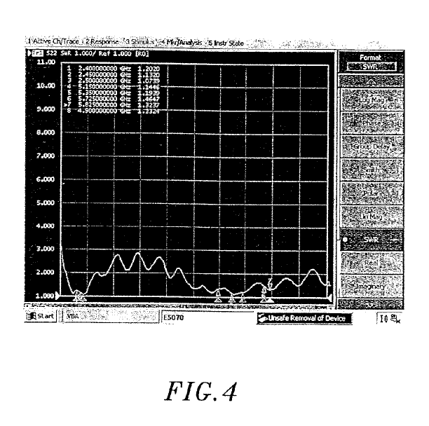

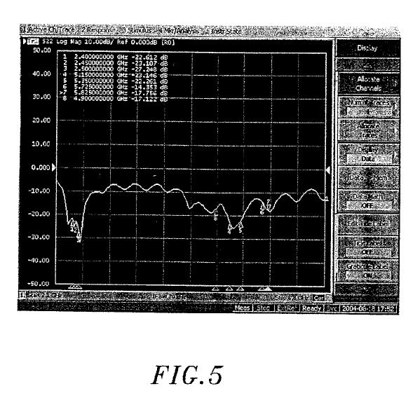

FIGS. 4 and 5 show a standing wave ratio chart and a return loss chart obtained from a use of the dual-band antenna of the present invention. As stated above, the second metal barrel 22 is kept axially spaced from the first metal barrel 21 at a predetermined gap, therefore the resonator 2 can produce a low frequency resonance and a high frequency resonance, and the standing wave ratio and the return loss can be maintained below a certain value, thereby obtaining a stable signal. Further, the gap between the first metal barrel 21 and the second metal barrel 22 has a great concern with the gain value of the low band resonance and high band resonance. Reducing the gap between the first metal barrel 21 and the second metal barrel 22 broaden the antenna bandwidth. Therefore, changing the gap between the first metal barrel 21 and the second metal barrel 22 relatively changes the impedance matching. Further, the gap between the first metal barrel 21 and the second metal barrel 22 is preferably set within 1/10λ˜ 1/25λ of the high band's center carrier and the length of the first metal barrel 21 and the second metal barrel 22 is preferably set to be about ¼λ of the low band when the antenna is used for a high frequency application. Therefore, broadening the bandwidth to achieve the desired impedance matching can be easily be achieved by means of changing the gap between the first metal barrel 21 and the second metal barrel 22 without creating a new mold or using a new fabrication implement.

Further, the inductor shell 4 protects the resonator 2 against deformation due to hitting of an external object or vibration by an external force accidentally, thereby amplifying the bandwidth of the low band and the high band. The inductor shell 4 can be made of plastics or Teflon. The first metal barrel 21 and the second metal barrel 22 are preferably made of copper.

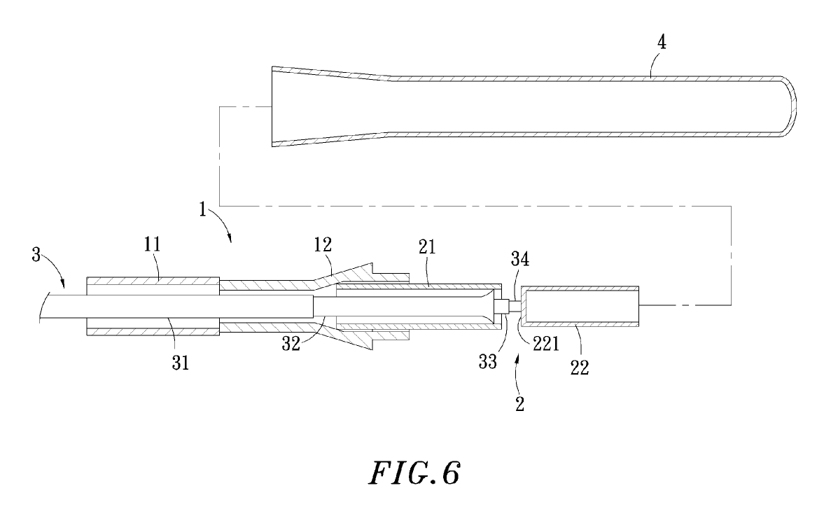

FIG. 6 shows an alternate form of the dual-band antenna. According to this embodiment, the second metal barrel 22 has a closed bottom end, forming a bonding face 221 for easy bonding of the center conductor 34 of the signal line (coaxial cable) 3.

In general, the invention has the second metal barrel 22 axially spaced from the first metal barrel 21 at a gap to broaden the bandwidth of the high band and the low band. By means of changing the gap between the first metal barrel 21 and the second metal barrel 22, the impedance matching is relatively changed. Therefore, the antenna of the present invention is conveniently adjustable. Further, because the holder base 12 is pivotally coupled to the mounting base 11, the user can adjust the azimuth of the antenna during use. Further, the inductor shell 4 protects the resonator 2 against deformation due to hitting of an external object or vibration by an external force accidentally, thereby increasing the bandwidth of the low band and the high band. Further, the present invention also effectively shortens the length of the antenna, satisfying the market demand for physical measurements —light, thin, short, and small. Further, the protection of the inductor shell 4 prevents deformation of the resonator 2 during transportation.

A prototype of dual-band antenna has been constructed with the features of FIGS. 1˜6. The dual-band antenna functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A dual-band antenna comprising a resonator holder; and a metal resonator connected to said resonator holder for receiving signals, said metal resonator comprising a first metal barrel and a second metal barrel for different bandwidth resonance,
wherein said first metal barrel and said second metal barrel are axially spaced from each other by a gap at about 1/10λ˜ 1/25λ of the high band's center carrier so that the bandwidth of the high band and the low band can be broadened and the impedance matching can be adjusted by means of changing the gap between said first metal barrel and said second metal barrel.

2. The dual-band antenna as claimed in claim 1, wherein said first metal barrel and said second metal barrel are made of copper.

3. The dual-band antenna as claimed in claim 1, wherein said first metal barrel and said second metal barrel have a length about ¼λ of the low band.

4. The dual-band antenna as claimed in claim 1, wherein said resonator holder comprises a mounting base, and a holder base pivotally coupled to said mounting base and adapted to hold said first metal barrel.

5. The dual-band antenna as claimed in claim 1, further comprising a signal line inserted through said resonator holder and said first metal barrel of said resonator, said signal line being formed of a coaxial cable comprising an outer insulative layer, a tubular braided conducting layer, an inner insulative layer, and a center conductor, said center conductor being covered within said inner insulative layer and soldered to said second metal barrel, said tubular braided conducting layer being covered on the periphery of said inner insulative layer within said outer insulative layer and connected to said first metal barrel.

6. The dual-band antenna as claimed in claim 1, further comprising an electrically insulative inductor shell capped on said resonator holder to protect said resonator on the inside.

7. The dual-band antenna as claimed in claim 6, wherein said inductor shell is molded from plastics.

8. The dual-band antenna as claimed in claim 6, wherein said inductor shell is made of Teflon.
